(19) United States
(12) Patent Application Publication
(10) Pub. No.: US 2013/0246449 A1
(43) Pub. Date: Sep. 19, 2013

(54) METHODS AND DEVICES FOR IDENTIFYING A RELATIONSHIP BETWEEN CONTACTS

(71) Applicants: Vadim Balannik, Arlington Heights, IL (US); Patrick Dell Ellis, Lake in the Hills, IL (US)

(72) Inventors: Vadim Balannik, Arlington Heights, IL (US); Patrick Dell Ellis, Lake in the Hills, IL (US)

(73) Assignee: RESEARCH IN MOTION LIMITED, Waterloo, ON (CA)

(21) Appl. No.: 13/635,347

(22) PCT Filed: Mar. 16, 2012
(86) PCT No.: PCT/US12/29524

§ 371 Date: Sep. 14, 2012

(51) Int. Cl. G06F 17/30

(52) U.S. Cl. CPC G06F 17/30345
USPC 707/758

(57) ABSTRACT

Methods and devices for identifying a relationship between contacts are described. In one example embodiment, the method includes: comparing data from a first contact record associated with a first contact to data from a second contact record associated with a second contact; determining, based on the comparison, whether the first contact is related to the second contact; and if the first contact and the second contact are determined to be related, establishing a relationship, in memory, between the first contact record and the second contact record.

### TECHNICAL FIELD

The present application relates to contact information management and, more particularly, to methods and electronic devices for identifying a relationship between contacts and methods and electronic devices for using such relationships.

### BACKGROUND

Electronic devices such as mobile phones, smart phones, PDAs (personal digital assistants), tablets, etc. are often equipped with an application to store and access contact information. For example, a contact manager application may allow a user to populate a contact record with contact information. The contact manager application may provide contact related functions; for example, the contact manager application may allow a user to input, modify, or view the contact information in a contact record.

Contact records are typically populated with limited information. For example, contact records may be populated with information which may be used to contact a person or business represented by the contact record, or information which may be used to identify the person or business represented by the contact record. For example, contact records often identify a contact's name, mailing address, place of work, email address, phone number, etc.

### BRIEF DESCRIPTION OF THE DRAWINGS

Reference will now be made, by way of example, to the accompanying drawings which show example embodiments of the present application, and in which:

FIG. 1 is a block diagram illustrating an example electronic device in accordance with example embodiments of the present disclosure;

FIG. 2 illustrates example contact records in accordance with example embodiments of the present disclosure;

FIG. 3 is a flowchart illustrating an example method of identifying related contacts in accordance with example embodiments of the present disclosure;

FIG. 4 is an example contact tree in accordance with example embodiments of the present disclosure;

FIG. 5 is a flowchart illustrating an example method of identifying a relationship type in accordance with example embodiments of the present disclosure; and

FIG. 6 is a flowchart illustrating an example method of populating a contact record based on information from a related contact record in accordance with example embodiments of the present disclosure.

Like reference numerals are used in the drawings to denote like elements and features.

### DETAILED DESCRIPTION

In one example embodiment, the present application describes a method performed by a processor. The method includes: comparing data from a first contact record associated with a first contact to data from a second contact record associated with a second contact; determining, based on the comparison, whether the first contact is related to the second contact; and if the first contact and the second contact are determined to be related, establishing a relationship, in memory, between the first contact record and the second contact record.

In another example embodiment, the present application describes an electronic device. The electronic device includes a memory storing a first contact record and a second contact record and a processor coupled to the memory. The processor is configured to: compare data from a first contact record associated with a first contact to data from a second contact record associated with a second contact; determine, based on the comparison, whether the first contact is related to the second contact; and if the first contact and the second contact are determined to be related, establish a relationship, in memory, between the first contact record and the second contact record.

In yet another example embodiment, the present application describes a method performed by a processor. The method includes: determining if contact information of a predetermined type is not included in a first contact record; determining if contact information of the predetermined type is included in a second contact record, the second contact record and the first contact record being associated with related contacts; and if contact information of the predetermined type is not included in the first contact record and contact information of the predetermined type is included in the second contact record, then populating a portion of the first contact record with the contact information of the predetermined type from the second contact record.

Other example embodiments of the present disclosure will be apparent to those of ordinary skill in the art from a review of the following detailed description in conjunction with the drawings.

Example embodiments of the present disclosure are not limited to any particular operating system, electronic device architecture, server architecture or computer programming language.

### Example Electronic Device

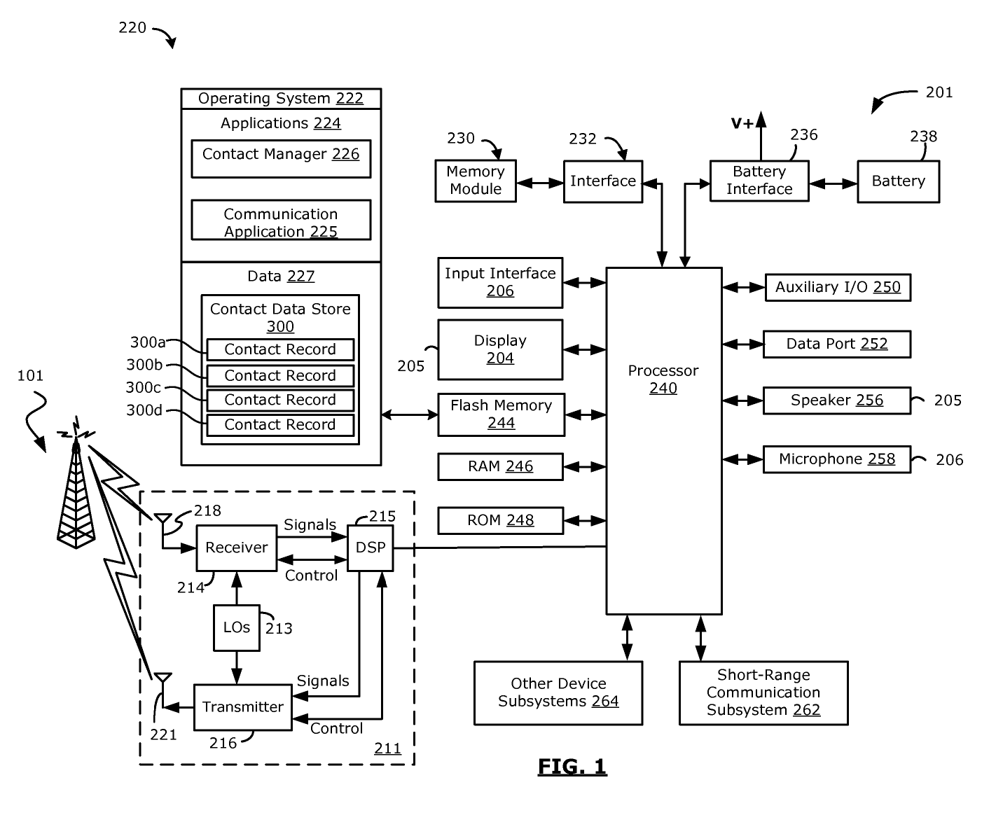

Reference is first made to FIG. 1 which illustrates an example electronic device 201. In the illustrated example embodiment, the electronic device 201 is a communication device, such as a mobile communication device. In at least some example embodiments, the electronic device 201 is a two-way communication device having data and voice communication capabilities, and the capability to communicate with other computer systems, for example, via the Internet. Depending on the functionality provided by the electronic device 201, in various example embodiments the electronic device 201 may be a multiple-mode communication device configured for data and voice communication, a mobile telephone such as a smart phone, a tablet computer such as a slate computer, a wearable computer such as a watch, a PDA (personal digital assistant), or a computer system.

A smartphone is a mobile phone which offers more advanced computing capabilities than a basic non-smartphone cellular phone. For example, a smartphone may have an ability to run third party applications which are stored on the smartphone.

A tablet computer (which may also be referred to as a tablet) is an electronic device 201 which is generally larger than a mobile phone (such as a smartphone) or personal digital assistant. Many mobile phones or personal digital assistants are designed to be pocket sized. That is, mobile phones or personal digital assistants are generally small enough to be carried by a person easily, often in a shirt or pant pocket while tablet computers are larger and may not fit within pant pockets. For example, many tablet computers have a height which is seven inches (7″) or more. In some example embodiments, the tablet computer may be a slate computer. A slate computer is a tablet computer which does not include a dedicated keyboard. A slate computer may allow for text input through the use of a virtual keyboard or an external keyboard which connects to the slate computer via a wired or wireless connection.

In other example embodiments, the electronic device 201 may be of a type not specifically listed above.

The electronic device 201 includes a housing (not shown) which houses components of the electronic device 201. The internal components of the electronic device 201 are constructed on a printed circuit board (PCB). The electronic device 201 includes a controller including at least one processor 240 (such as a microprocessor) which controls the overall operation of the electronic device 201. The processor 240 interacts with device subsystems such as a wireless communication subsystem 211 for exchanging radio frequency signals with a wireless network 101 to perform communication functions. The processor 240 interacts with additional device subsystems including one or more input interfaces 206 (such as a keyboard, one or more control buttons, one or more microphones 258, and/or a touch-sensitive overlay associated with a touchscreen display), flash memory 244, random access memory (RAM) 246, read only memory (ROM) 248, auxiliary input/output (I/O) subsystems 250, a data port 252 (which may be a serial data port, such as a Universal Serial Bus (USB) data port), one or more output interfaces 205 (such as a display 204, one or more speakers 256, or other output interfaces 205), a short-range communication subsystem 262, and other device subsystems generally designated as 264. Some of the subsystems shown in FIG. 1 perform communication-related functions, whereas other subsystems may provide “resident” or on-device functions.

The electronic device 201 may include a touch-sensitive display 204 which may be referred to as a touchscreen or a touchscreen display 204. The touchscreen display 204 may be constructed using a touch-sensitive input surface connected to an electronic controller. The touch-sensitive input surface overlays the touchscreen display 204 and may be referred to as a touch-sensitive overlay. The touch-sensitive overlay and the electronic controller provide a touch-sensitive input interface 206 and the processor 240 interacts with the touch-sensitive overlay via the electronic controller. That is, the touchscreen display 204 acts as both an input interface 206 and an output interface 205.

The communication subsystem 211 includes a receiver 214, a transmitter 216, and associated components, such as one or more antenna elements 218 and 221, local oscillators (LOs) 213, and a processing module such as a digital signal processor (DSP) 215. The antenna elements 218 and 221 may be embedded or internal to the electronic device 201 and a single antenna may be shared by both receiver 214 and transmitter 216. The particular design of the wireless communication subsystem 211 depends on the wireless network 101 in which the electronic device 201 is intended to operate.

The electronic device 201 may communicate with any one of a plurality of fixed transceiver base stations of the wireless network 101 within its geographic coverage area. The electronic device 201 may send and receive communication signals over the wireless network 101 after the required network registration or activation procedures have been completed. Signals received by the antenna 218 through the wireless network 101 are input to the receiver 214, which may perform such common receiver functions as signal amplification, frequency down conversion, filtering, channel selection, etc., as well as analog-to-digital (A/D) conversion. A/D conversion of a received signal allows more complex communication functions such as demodulation and decoding to be performed in the DSP 215. In a similar manner, signals to be transmitted are processed, including modulation and encoding, for example, by the DSP 215. These DSP-processed signals are input to the transmitter 216 for digital-to-analog (D/A) conversion, frequency up conversion, filtering, amplification, and transmission to the wireless network 101 via the antenna 221. The DSP 215 not only processes communication signals, but may also provide for receiver and transmitter control. For example, the gains applied to communication signals in the receiver 214 and the transmitter 216 may be adaptively controlled through automatic gain control algorithms implemented in the DSP 215.

In some example embodiments, the auxiliary input/output (I/O) subsystems 250 may include an external communication link or interface, for example, an Ethernet connection. The electronic device 201 may include other wireless communication interfaces for communicating with other types of wireless networks, for example, a wireless network such as an orthogonal frequency division multiplexed (OFDM) network. The auxiliary I/O subsystems 250 may include a pointing or navigational tool (input device) such as a clickable trackball or scroll wheel or thumbwheel, or a vibrator for providing vibratory notifications in response to various events on the electronic device 201 such as receipt of an electronic message or incoming phone call, or for other purposes such as haptic feedback (touch feedback).

In some example embodiments, the electronic device 201 also includes a removable memory module 230 (typically including flash memory) and a memory module interface 232. Network access may be associated with a subscriber or user of the electronic device 201 via the memory module 230, which may be a Subscriber Identity Module (SIM) card for use in a GSM network or other type of memory module for use in the relevant wireless network. The memory module 230 may be inserted in or connected to the memory module interface 232 of the electronic device 201.

The electronic device 201 may store data 227 in an erasable persistent memory, which in one example embodiment is the flash memory 244. In various example embodiments, the data 227 may include service data having information required by the electronic device 201 to establish and maintain communication with the wireless network 101. The data 227 may also include user application data such as email messages, address book and contact information, calendar and schedule information, notepad documents, image files, and other commonly stored user information stored on the electronic device 201 by its user, and other data. The data 227 stored in the persistent memory (e.g. flash memory 244) of the electronic device 201 may be organized, at least partially, into a number of databases or data stores each containing data items of the same data type or associated with the same application. For example, email messages, contact records 300a-300d, and task items may be stored in individual databases within the memory of the electronic device 201. By way of example, contact records 300a-300d may be stored in a contact data store 300 which may be a database which is configured for storing the contact records.

The data port 252 may be used for synchronization with a user's host computer system (not shown). The data port 252 enables a user to set preferences through an external device or software application and extends the capabilities of the electronic device 201 by providing for information or software downloads to the electronic device 201 other than through the wireless network 101. The alternate download path may, for example, be used to load an encryption key onto the electronic device 201 through a direct, reliable and trusted connection to thereby provide secure device communication.

In some example embodiments, the electronic device 201 is provided with a service routing application programming interface (API) which provides an application with the ability to route traffic through a serial data (i.e., USB) or Bluetooth® (Bluetooth® is a registered trademark of Bluetooth SIG, Inc.) connection to the host computer system using standard connectivity protocols. When a user connects their electronic device 201 to the host computer system via a USB cable or Bluetooth® connection, traffic that was destined for the wireless network 101 is automatically routed to the electronic device 201 using the USB cable or Bluetooth® connection. Similarly, any traffic destined for the wireless network 101 is automatically sent over the USB cable Bluetooth® connection to the host computer system for processing.

The electronic device 201 also includes a battery 238 as a power source, which is typically one or more rechargeable batteries that may be charged, for example, through charging circuitry coupled to a battery interface 236 such as the serial data port 252. The battery 238 provides electrical power to at least some of the electrical circuitry in the electronic device 201, and the battery interface 236 provides a mechanical and electrical connection for the battery 238. The battery interface 236 is coupled to a regulator (not shown) which provides power V+ to the circuitry of the electronic device 201.

The short-range communication subsystem 262 is an additional optional component which provides for communication between the electronic device 201 and different systems or devices, which need not necessarily be similar devices. For example, the short-range communication subsystem 262 may include an infrared device and associated circuits and components, or a wireless bus protocol compliant communication mechanism such as a Bluetooth® communication module to provide for communication with similarly-enabled systems and devices.

A pre-determined set of applications that control basic device operations, including data and possibly voice communication applications will normally be installed on the electronic device 201 during or after manufacture. Additional applications and/or upgrades to an operating system 222 or software applications 224 may also be loaded onto the electronic device 201 through the wireless network 101, the auxiliary I/O subsystem 250, the data port 252, the short-range communication subsystem 262, or other suitable device subsystems 264. The downloaded programs or code modules may be permanently installed, for example, written into the program memory (i.e. the flash memory 244), or written into and executed from the RAM 246 for execution by the processor 240 at runtime.

In some example embodiments, the electronic device 201 may provide two principal modes of communication: a data communication mode and a voice communication mode. In the data communication mode, a received data signal such as a text message, an email message, or a web page download will be processed by the communication subsystem 211 and input to the processor 240 for further processing. For example, a downloaded web page may be further processed by a browser application or an email message may be processed by the email messaging application and output to the touchscreen display 204. A user of the electronic device 201 may also compose data items, such as email messages, for example, using the input devices, such as the touchscreen display 204. These composed items may be transmitted through the communication subsystem 211 over the wireless network 101.

In the voice communication mode, the electronic device 201 provides telephony functions and operates as a typical cellular phone. The overall operation is similar to the data communication mode, except that the received signals would be output to the speaker 256 and signals for transmission would be generated by a transducer such as the microphone 258. The telephony functions are provided by a combination of software/firmware (i.e., a voice communication module) and hardware (i.e., the microphone 258, the speaker 256 and input devices). Alternative voice or audio I/O subsystems, such as a voice message recording subsystem, may also be implemented on the electronic device 201. Although voice or audio signal output is typically accomplished primarily through the speaker 256, the touchscreen display 204 may also be used to provide an indication of the identity of a calling party, duration of a voice call, or other voice call related information.

The processor 240 operates under stored program control and executes software modules 220 stored in memory such as persistent memory, for example, in the flash memory 244. As illustrated in FIG. 1, the software modules 220 include operating system software 222, and software applications 224 which may include a contact manager 226 and/or a communication application 225. In the example embodiment of FIG. 1, the contact manager 226 and the communication application 225 are implemented as separate stand-alone applications 224, but in other example embodiments, the contact manager 226 and/or the communication application 225 may be implemented as part of the operating system 222 or another application 224. For example, in some example embodiments, the contact manager 226 and the communication application 225 may be implemented in a single application.

The electronic device 201 may include a range of additional software applications 224, including for example, a notepad application, a mapping application, or a media player application, or any combination thereof. Each of the software applications 224 may include layout information defining the placement of particular fields and graphic elements (e.g. text fields, input fields, icons, etc.) in the user interface (i.e. the touchscreen display 204) according to the application. In at least some example embodiments, the software applications 224 may include pre-determined gesture information defining functionalities associated with the pre-determined gestures received via the touchscreen display 204. For example, a software application 224 may determine a finger swiping movement (i.e. a pre-determined gesture) on the touchscreen display 204 as a scrolling function.

The software modules 220 or parts thereof may be temporarily loaded into volatile memory such as the RAM 246. The RAM 246 is used for storing runtime data variables and other types of data or information. Although specific functions are described for various types of memory, this is merely one example, and a different assignment of functions to types of memory could also be used.

The communication application 225 may be configured to allow the electronic device 201 to communicate with other electronic devices. More particularly, the communication application 225 may allow a user of the electronic device to communicate with a contact of that user. The contact may, for example, be a person or business that is known to the user. In at least some example embodiments, the communication application 225 may be a voice communication application which allows the electronic device to engage in an audio-based communication (such as a phone call) with another electronic device. In some example embodiments, the communication application 225 may be an electronic messaging application which is configured to allow a user to compose, send, and/or receive electronic messages (such as email messages, text messages, instant messages, etc.). While a single communication application 225 is illustrated in FIG. 1, the electronic device 201 may have multiple communication applications 225 which allow the electronic device 201 to provide various types of communications.

The contact manager 226 performs the functions of an address book and allows contact records 300a-300d to be created and stored in memory. For example, the contact manager 226 may permit contact records 300a-300d to be stored in the contact data store 300 in the data area 227 of memory.

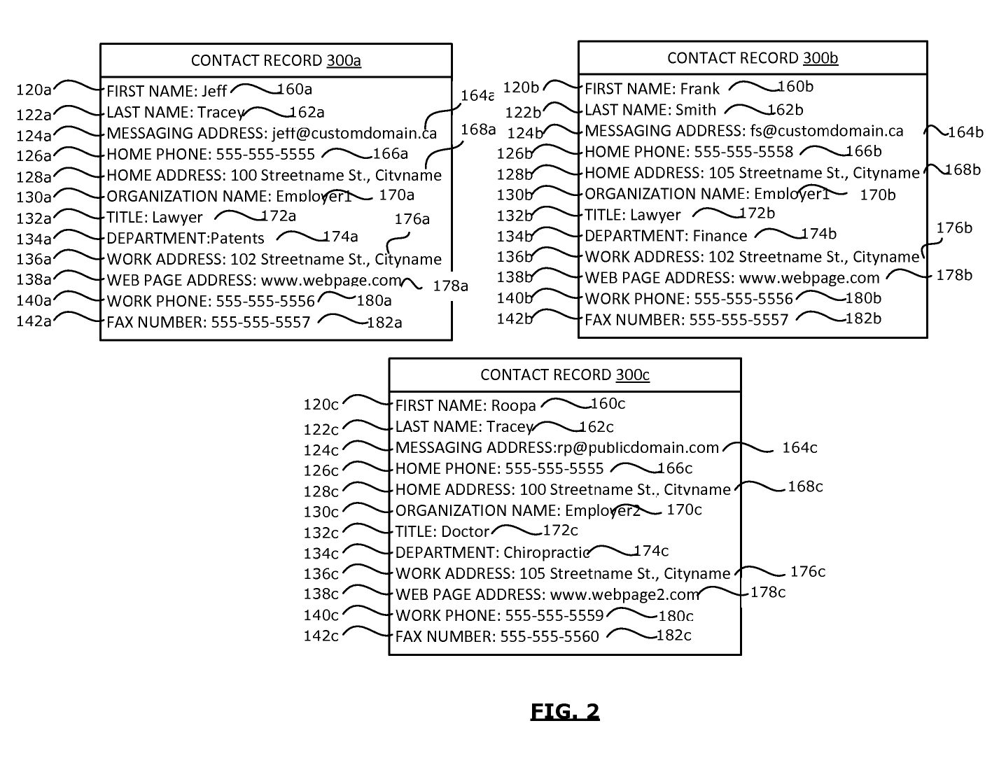

Contact records 300a-300d are records which store contact information for a contact. The contact may, for example, be a person or business associated with a user of the electronic device 201. Contact records 300a-300d may include information such as identifying information for a contact. The identifying information may include, for example, one or more names, phone numbers, mailing addresses and/or electronic messaging addresses associated with the contact. Example contact records will be discussed in greater detail below with reference to FIG. 2.

The contact manager 226 is configured to receive new contact records 300a-300d from one or more input interfaces 206 associated with the electronic device 201. For example, a user of the electronic device 201 may interact with an input interface 206 (for example, the touchscreen display 204) in order to input an instruction to the contact manager 226 to create a new contact record 300a-300d. Similarly, in at least some example embodiments, the contact manager 226 is configured to receive contact records 300a-300d via the communication subsystem 211. For example, in some example embodiments, a contact record 300a-300d may be received in an electronic message, such as an email. The contact manager 226 may store contact records 300a-300d received via an input interface 206 or a communication subsystem 211 in the contact data store 300. Such storage may occur automatically or at the request of the user (e.g. by selecting an option, such as a “save option”, to store a contact record 300a-300d to memory).

The contact manager 226 may be configured to permit contact records to be created in other ways apart from those mentioned above. For example, in some example embodiments, the contact manager 226 may allow one or more contact records 300a-300d to be imported from another application and/or file.

In at least some example embodiments, after contact records 300a-300d are created they may be accessed by the contact manager 226. In at least some example embodiments, contact records 300a-300d may be accessed by other applications 224 (such as the communication application 225). For example, in at least some example embodiments, some applications 224 (such as the communication application 225) may access the contact records 300a-300d directly. In other example embodiments, the contact manager 226 may control access to the contact records 300a-300d. In at least some such example embodiments, other applications 224 (such as the communication application 225) may access the contact records 300a-300d by requesting access from the contact manager 226. For example, in at least some example embodiments, the contact manager 226 may be equipped with an application programming interface (API) which allows other applications (such as the communication application 225) to request information associated with contact records 300a-300d. In response to receiving such requests via an API, the contact manager 226 may retrieve the requested information and provide the information to the requesting application 224.

In the example illustrated, four contact records are shown including a first contact record 300a, a second contact record 300b, a third contact record 300c, and a fourth contact record 300d. However, the contact data store 300 may store more or less contact records 300a-300d than are shown in FIG. 1.

The contact records 300a-300d may be received and/or stored in vCard (virtual card) format or in another format which provides contact information.

In some example embodiments, the contact manager 226 may be configured to identify relationships between contacts. For example, in some example embodiments, the contact manager 226 may be configured to compare data from two contact records and may determine, based on the comparison, whether the contacts associated with the contact records are related. For example, in some example embodiments, the contact manager 226 may identify contact information which is common between the contact records and may determine, based on the common information, whether a relationship exists between those contact records. For example, a common home address, fax number, home phone number, last name, organization name, work phone number, work address, or web page address may be considered to be indicia that the contacts may be related. If enough indicia suggests that the contacts may be related, then the contact manager 226 may determine that the contacts are related.

Where the contact manager 226 determines that two contacts associated with two contact records 300a-300d are related, the contact manager 226 may establish a relationship between the contact records for those contacts in memory. That is, the contact manager 226 may store relationship information in memory to track the relationships between contact records 300a-300d. The relationship information may, for example, specify whether a relationship exists between two contact records (that is, whether the contacts associated with the two contact records are related). That is, the relationship information may provide a link between two contact records if the contacts for those two records are considered to be related.

In some example embodiments, the contact manager 226 may be configured to attempt to determine the relationship type of a relationship (if any) between contacts based on the information in the contact records for those contacts. For example, in some example embodiments, the contact manager 226 may attempt to determine whether two contacts have a familial relationship. That is, the contact manager 226 may determine whether two contacts are family members. For example, where the contacts share enough common home contact information (such as a common home number, home fax number, home address, etc.) and/or a common last name, then the contact manager 226 may determine that the contacts are family members. The determination regarding whether the contacts share enough home contact information may be made according to one or more predetermined rules. The predetermined rules may specify a threshold amount of contact information which must be common before the contact manager 226 will determine that the relationship exists. For example, a predetermined rule may specify that, if any home contact information is common between two contact records 300a-300d, then the contacts associated with those contact records will be determined to be family members. In some example embodiments, a predetermined rule may specify that two contacts must have the same last name before the contact manager 226 will determine that they are family members. Such a rule may be used to prevent the contact manager 226 from falsely determining that two contacts are family members when they are merely roommates.

In some example embodiments, the contact manager 226 may attempt to determine whether two contacts have a work relationship. That is, the contact manager 226 may determine whether two contacts are co-workers. For example, where the contacts share enough common work contact information (such as a common organization name (e.g. company name), work fax number, work phone number, work address, or web page address), the contact manager 226 may determine that the contacts are co-workers. The determination regarding whether the contacts share enough work contact information may be made according to one or more predetermined rules. The predetermined rules may specify a threshold amount of contact information which must be common before the contact manager 226 will determine that a relationship exists. For example, a predetermined rule may specify that, if any work contact information is common between two contact records, then the contacts associated with those contact records will be determined to be co-workers. For example, using this rule, the existence of any one of the following may cause the contact manager 226 to determine that the contacts are co-workers: a common organization name, work fax number, work phone number, work address, or web page address.

Accordingly, in at least some example embodiments, the relationship information which is stored may specify a relationship type. That is, the contact manager 226 may store information which specifies the type of relationship which exists between two contacts. As noted above, in at least some example embodiments, a relationship type may specify whether contacts have a familial relationship (i.e. whether the contacts are members of the same family). In at least some example embodiments, a relationship type may specify whether contacts have a work relationship (i.e. whether the contacts are co-workers).

The contact manager 226 may be configured to store other relationship types in other example embodiments. For example, in some example embodiments, the contact manager 226 may store relationship types which are more granular than the examples listed above (i.e. more granular than familial and/or work). For example, in at least some example embodiments, relationship information may be stored which specifies whether two contacts are: spouses, cohabitants, siblings, parent/child, cousins, boss/subordinate, etc.

The contact manager 226 may not be able to accurately identify all of the relationship types listed above from the contact records alone. Instead, in some example embodiments, a user may assist the contact manager 226 in identifying relationships and/or relationship types. For example, in some example embodiments, the contact manager 226 may allow a user to manually input a relationship and/or a relationship type between two contacts using an input interface 206 associated with the electronic device 201.

In some example embodiments, the contact manager 226 may not predict the existence of a relationship and/or the relationship type; instead, a user may input such information. In other example embodiments, user input may be used to aid the predictive capabilities of the contact manager 226. That is, the contact manager 226 may predict the existence of a relationship and/or a relationship type based on the information in the contact records, but a user may confirm such information and/or further clarify the nature of the relationship before the electronic device 201. For example, if the contact manager 226 determines that a familial relationship exists, it may then prompt a user to further clarify the nature of the familial relationship (i.e. whether the contacts are siblings, cousins, parent/child, spouses, etc.).

After relationship information (such as the existence of a relationship and/or the relationship type of a relationship) is determined for two contact records, the contact manager 226 may store the relationship information in memory. That is, the contact manager 226 tracks which contact records are related and, in at least some example embodiments, the nature of that relationship (i.e. the relationship type). Such relationship information may, in at least some example embodiments, be stored within the contact records 300a-300d. For example, a first contact record 300a may store an identifier of another contact record 300b, 300c, 300d which is related to the first contact record. Similarly, the first contact record 300a may store information which specifies the relationship type of the relationship between the contact records. In some example embodiments, the relationship information may be stored outside of the contact records; for example, in a separate relationship database (not shown).

In some example embodiments, the contact manager 226 may be configured to use relationship information to populate an incomplete portion of a contact record 300a-300d. For example, the contact manager 226 may populate a portion of a contact record based on data from a related contact record. By way of example, if a familial relationship exists between two contacts, a home phone number for a contact record associated with one of the contacts may be added to a contact record associated with another one of the contacts.

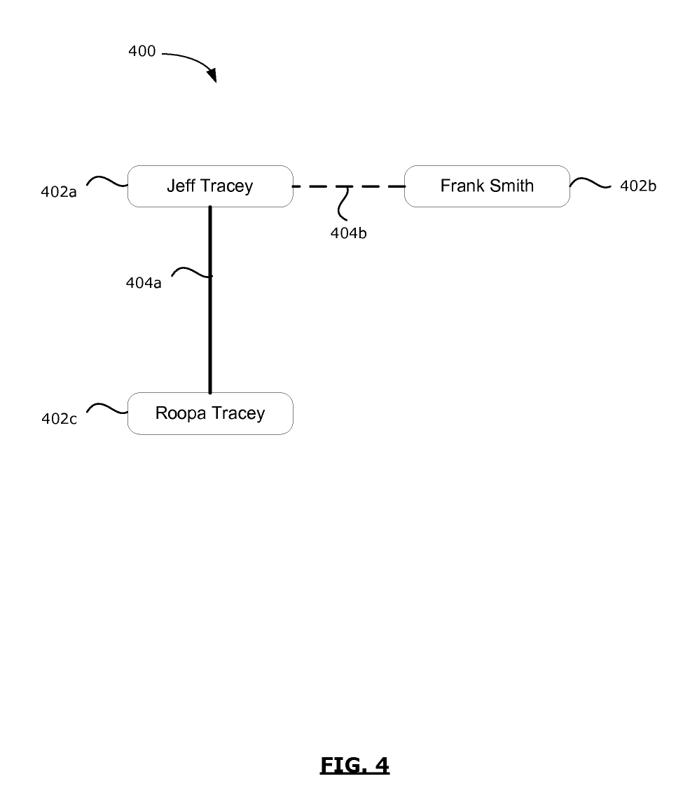

In some example embodiments, the contact manager 226 and/or the communication application 225 may be configured to display a graphical depiction of contacts and their relationships. For example, the contact manager 226 may use the relationship information to display a contact tree 400 (of FIG. 4) of contacts. The contact tree is a display screen which visually depicts the relationships of contacts. For example, the contact tree may include a contact identifier for a contact (which may be a name associated with the contact) and a line may connect contact identifiers for related contacts. That is, a line may be used to visually depict a relationship.

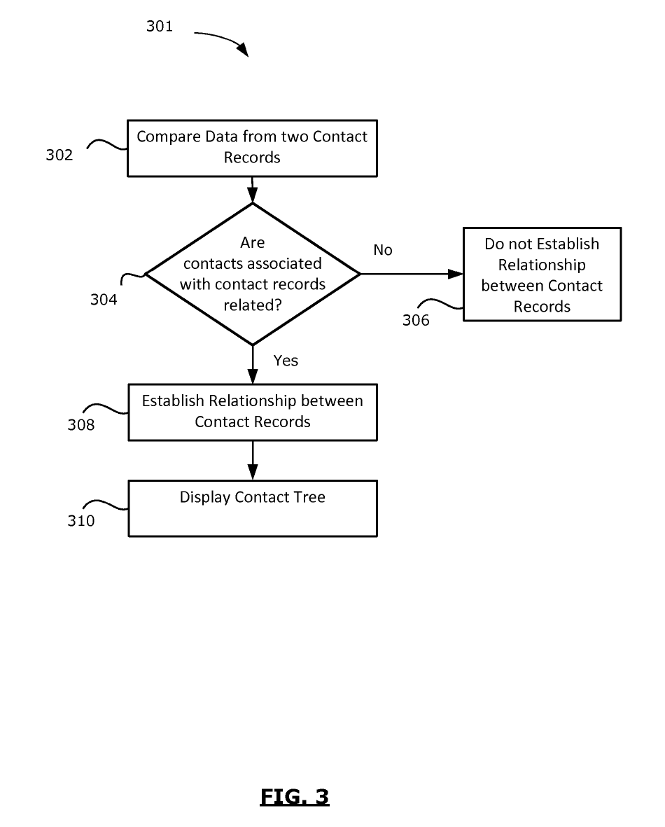

Specific functions and features of the contact manager 226 will be discussed in greater detail below with reference to FIGS. 3 to 6.

In at least some example embodiments, the operating system 222 may perform some or all of the functions of the contact manager 226 and/or the communication application 225. In other example embodiments, the functions or a portion of the functions of the contact manager 226 and/or the communication application 225 may be performed by one or more other applications. Further, while the contact manager 226 and the communication application 225 have each been illustrated as a single block, the contact manager 226 and the communication application 225 may include a plurality of software modules. In at least some example embodiments, these software modules may be divided among multiple applications.

### Example Contact Record

Accordingly, in some example embodiments of the present disclosure, the electronic device 201 (FIG. 1) may be configured to examine contact records in order to identify relationships between contacts. For example, the electronic device 201 may compare information in contact records in order to determine whether the contacts associated with those contact records are related.

Example contact records 300a-300c will now be discussed with reference to FIG. 2. Referring now to FIG. 2, three example contact records 300a-300c are illustrated. These example contact records 300a-300c include a first contact record 300a, a second contact record 300b, and a third contact record 300c. In the example illustrated, the contact associated with the first contact record 300a is related to both the contact associated with the second contact record 300b and the contact associated with the third contact record 300c. More particularly, the contact associated with the first contact record 300a and the contact associated with the second contact record 300b are co-workers and the contact associated with the first contact record 300a and the contact associated with the third contact record are family members (i.e. they have a familial relationship).

The contact records 300a-300c, may include contact information associated with a contact. A contact is an entity such as a person or business which is associated with a user of the electronic device 201.

In at least some example embodiments, the contact records 300a-300c include a plurality of fields. The fields may, for example, include one or more name fields which may store a name of a contact, such as a personal name (e.g. a first name, middle name, last name, and/or nickname, etc.). In at least some example embodiments, a contact record 300a-300c may include a first name field 120a, 120b, 120c and a last name field 122a, 122b, 122c. The first name field 120a, 120b, 120c may store a first name 160a, 160b, 160c associated with the contact (which may also be referred to as a given name) and the last name field 122a, 122b, 122c may store a last name 162a, 162b, 162c associated with the contact (which may also be referred to as a surname).

While the example embodiment illustrates contact records 300a-300c which include separate first name fields 120a, 120b, 120c and separate last name fields 122a, 122b, 122c, in other example embodiments, a single name field may be used to store both a first name and a last name for the contact. Furthermore, in other example embodiments, a contact record 300a-300c may include additional name fields; for example, a nickname field may be used for storing a nickname associated with a contact.

As will be described in greater detail below, in at least some example embodiments, the electronic device 201 may compare the last name of two contacts in order to determine whether those contacts are related. More particularly, the electronic device 201 may compare the last name of the two contacts in order to determine whether the contacts share a familial relationship.

The example contact records 300a-300c also include a messaging address field 124a, 124b, 124c. The messaging address field 124a, 124b, 124c may be used for storing a messaging address 164a, 164b, 164c associated with the contact. For example, in the example illustrated, the messaging address field 124a, 124b, 124c stores an email address. However, in other example embodiments, the messaging address field may store a messaging address associated with another type of electronic messaging (such as an instant messaging address, etc.). Furthermore, in at least some example embodiments, a contact record 300a-300c may include multiple messaging address fields 124a, 124b, 124c for storing multiple messaging addresses. In at least some example embodiments, the contact records 300a-300c may store messaging addresses of a plurality of types.

Where the contact record 300a-300c stores an email address, the email address may include a local-part portion and a domain name portion. The domain name portion of the email address is the portion of the email address which follows the “@” sign. In the example embodiment illustrated, the domain name portion of email address in the first contact record 300a is customdomain.ca.

As will be described in greater detail below, in at least some example embodiments, the electronic device 201 may compare the domain name portion of the email addresses in two contact records to determine whether the contacts associated with the contact records are related. For example, in at least some example embodiments, the electronic device 201 may determine whether the email addresses have common domain name portions and whether those common domain name portions are custom domain names. Custom domain names are domain names which are not typically associated with personal email accounts. For example, the custom domain name “rim” in www.rim.com, identifies the company Research In Motion. In at least some example embodiments, the electronic device will determine whether the domain name portion identifies a public email service. A public email service is an email service which is widely available to the public. For example, Gmail™, Hotmail™, Yahoo Mail™ are examples of public email services.

Where an email address is associated with a public email service, the electronic device 201 may determine that the email address provides little or no probative value in identifying a relationship. However, if the email address is not associated with a public email service (e.g. if the email address is an email address which has a custom domain name portion) and two contacts have contact records with the same domain name portion of an email address, then the electronic device 201 may determine that the contacts are related. In at least some example embodiments, if the email address is not associated with a public email service (e.g. if the email address is an email address which has a custom domain name portion) and two contacts have contact records with the same domain name portion of an email address, then the electronic device 201 may determine that the contacts have a work relationship. That is, if such criteria are satisfied, then the electronic device 201 may determine that the contacts are co-workers.

In the example illustrated, the first contact record 300a includes a domain name portion (e.g. customdomain.ca) of the email address which is custom (i.e. which is not associated with a public email service). The email address in the second contact record 300b includes the same custom domain name portion in the email address. Accordingly, in some example embodiments, the electronic device 201 may determine that the contacts associated with the first contact record 300a and the second contact record 300b are related. The domain name portion of the email address of the third contact record 300c is a domain name associated with a public email service (i.e. publicdomain.com) and so, in at least some example embodiments, the electronic device 201 may determine that the email address of the third contact record offers no probative value when identifying relationships.

In the example illustrated, the contact records 300a-300c include home contact information fields, including a home phone field 126a, 126b, 126c (which may store a home phone number 166a, 166b, 166c for the contact) and a home address field 128a, 128b, 128c (which may store a home address 168a, 168b, 168c for the contact).

As will be described in greater detail below, in at least some example embodiments, the electronic device 201 may compare one or more home contact information fields from a plurality of contact records 300a-300c to determine whether the contacts associated with those contact records 300a-300c are related. For example, in some example embodiments, the electronic device 201 may compare the home phone numbers 166a, 166b, 166c in two contact records 300a-300c to determine whether the contacts associated with the contact records are related. That is, the electronic device 201 may determine that the contacts associated with two contact records are related by comparing the home phone numbers. Where the home phone numbers are the same, then the electronic device 201 may determine that the contacts associated with those contact records may be related. In at least some example embodiments, where the home phone numbers are the same, then the electronic device 201 may determine that the contacts associated with those contact records have a familial relationship. For example, in FIG. 2, the first contact record 300a and the third contact record 300c have a common home phone number 166a, 166c, but the second contact record 300b has a home phone number 166b which is not the same as the home phone number for the first contact record and the third contact record. In such an example embodiment, the electronic device 201 may determine that the contact associated with the first contact record 300a is a family member of the contact associated with the third contact record 300c.

Similarly, in at least some example embodiments, the electronic device 201 may compare the home address 168a, 168b, 168c of in two contact records 300a-300c to determine whether the contacts associated with the contact records are related. That is, the electronic device 201 may determine that the contacts associated with two contact records are related by comparing the home addresses. Where the home addresses 168a, 168b, 168c are the same, then the electronic device 201 may determine that the contacts associated with those contact records 300a-300d may be related. In at least some example embodiments, where the home addresses are the same, then the electronic device 201 may determine that the contacts associated with those contact records have a familial relationship. For example, in FIG. 2, the first contact record 300a and the third contact record 300c have a common home address 168a, 168c, but the second contact record 300b has a home address 168b which is not the same as the home address for the first contact record 300a and the third contact record 300c. In such an example embodiment, the electronic device 201 may determine that the contact associated with the first contact record is a family member of the contact associated with the third contact record.

In at least some example embodiments, the contact records 300a-300d may include one or more work contact information fields which may be populated with work contact information. As will be described in greater detail below, in at least some example embodiments, the electronic device 201 may compare the work contact information in a plurality of contact records 300a-300c to determine whether the contacts associated with those contact records 300a-300c are related. For example, in some example embodiments, the electronic device 201 may compare the work contact information to determine whether the contacts are co-workers. The comparison may be performed in the same manner as described above with respect to the home information fields.

In the example illustrated, the work contact information fields include a organization name field 130a, 130b, 130c (which may be used to store a organization name 170a, 170b, 170c associated with the contact, such as the contact's employer), a title field 132a, 132b, 132c (which may be used to store a work title 172a, 172b, 172 for the contact), a department name field 134a, 134b, 134c (which may be used to store a department name 174a, 174b, 174c for the contact), a work address field 136a, 136b, 136c (which may be used to store a work address 176a, 176b, 176c for the contact), a web page address field 138a, 138b, 138c (which may be used to store a web page address 178a, 178b, 178c for the contact, such as a web page for their employer), a work phone number field 140a, 140b, 140c (which may be used to store a work phone number 180a, 180b, 180c for the contact), and a fax number field 142a, 142b, 142c (which may be used to store a fax number 182a, 182b, 182c for the contact, such as a work fax number).

The contact record 300a-300c may, in other example embodiments, include additional fields which are not specifically recited herein. Furthermore, in some example embodiments, a contact record 300a-300c may not include all of the fields discussed above. In some example embodiments, one or more of the fields may be empty. That is, in at least some example embodiments, some of the fields may not be populated with information. That is, a contact record may be incomplete (i.e. it may not include all types of contact information).

### Identifying Related Contacts

Referring now to FIG. 3, a flowchart of an example method 301 of identifying related contacts is illustrated. The electronic device 201 (of FIG. 1) may be configured to perform the method 301 of FIG. 3. In at least some example embodiments, the processor 240 of the electronic device 201 is configured to perform the method 301 of FIG. 3. One or more applications 224 (of FIG. 1) or modules on the electronic device 201 (of FIG. 1) may contain computer readable instructions which cause the processor 240 (of FIG. 1) of the electronic device 201 to perform the method 301 of FIG. 3. In at least some example embodiments, the contact manager 226 (of FIG. 1) and/or the communication application 225 (of FIG. 1) stored in memory of the electronic device 201 is configured to perform the method 301 of FIG. 3. More particularly, the contact manager 226 and/or the communication application 225 may contain computer readable instructions which, when executed, cause the processor 240 to perform the method 301 of FIG. 3. It will be appreciated that the method 301 of FIG. 3 may, in at least some example embodiments, be provided by other software applications or modules apart from those specifically discussed above, such as the operating system 222. Accordingly, any features which are referred to as being performed by the electronic device 201 may be performed by any one or more of the software applications or modules referred to above or other software modules. Accordingly, references to the “contact manager” below could be replaced with the names of other applications or modules in other example embodiments.

In at least some example embodiments, at least some of the method 301 of FIG. 3 may be performed by or may rely on other applications 224 or modules which interface with the contact manager 226. For example, the contact manager 226 may be equipped with an application programming interface (API) which allows other software applications 224 or modules (such as the communication application 225) to access features of the contact manager 226.

At 302, the contact manager 226 may compare data from two contact records. For example, the contact manager 226 may compare data from a first contact record 300a associated with a first contact with data from a second contact record 300b associated with a second contact.

In at least some example embodiments, at 302, the contact manager 226 may compare the contents of one or more fields of the first contact record 300a to the contents of one or more similar fields of the second contact record 300b to determine whether the fields represent the same content. For example, in some example embodiments, the contact manager 226 compares a home address 168a of first contact record 300a (which may be contained in a home address field 128a) to a home address 168b of the second contact record 300b (which may be contained in a home address field 128b) to determine whether the contacts have the same home address.

Similarly, in at least some example embodiments, at 302, the contact manager 226 compares a work address 176a of first contact record 300a (which may be contained in a work address field 136a) to a work address 176b of the second contact record 300b (which may be contained in a work address field 136b) to determine whether the contacts have the same work address.

Similarly, in at least some example embodiments, at 302, the contact manager 226 compares a phone number contained in the first contact record with a phone number contained in the second contact record to determine whether the contacts have the same phone number. For example, in at least some example embodiments, at 302, the contact manager 226 compares a home phone number 166a of the first contact record 300a (which may be contained in a home phone number field 126a) with a home phone number 166b of the second contact record 300b (which may be contained in a home phone number field 126b) to determine whether the contacts have the same home phone number.

Similarly, in at least some example embodiments, at 302, the contact manager 226 compares a work phone number 180a of the first contact record 300a (which may be contained in a work phone number field 140a) with a work phone number 180b of the second contact record 300b (which may be contained in a work phone number field 140b) to determine whether the contacts have the same work phone number. In at least some example embodiments, the contact manager 226 may determine that the contacts have the same work phone number if the contacts have a common external phone number, even if the contacts do not have a common extension.

Similarly, in at least some example embodiments, at 302, the contact manager 226 compares a web page address 178a contained in a first contact record 300a (which may be contained in a web page address field 138a) with a web page address 178b contained in a second contact record 300b (which may be contained in a web page address field 138b) to determine whether the web page addresses are the same for both contacts.

Similarly, in at least some example embodiments, at 302, the contact manager 226 compares a organization name 170a contained in a first contact record 300a (which may be contained in a organization name field 130a) with a organization name 170b contained in a second contact record 300b (which may be contained in a organization name field 130b) to determine whether the organization names associated with both contacts are the same.

Similarly, in at least some example embodiments, at 302, the contact manager 226 compares a fax number 182a contained in a first contact record 300a (which may be contained in a fax number field 142a) with a fax number 182b contained in a second contact record 300b (which may be contained in a fax number field 142b) to determine whether the fax numbers associated with both contacts are the same.

Similarly, in at least some example embodiments, at 302, the contact manager 226 compares a messaging address 164a contained in a first contact record 300a (which may be contained in a messaging address field 124a) with a messaging address 164b contained in a second contact record 300b (which may be contained in a fax number field 142b) to determine whether the messaging addresses associated with both contacts are the same or related. For example, in some example embodiments, at 302 the contact manager may compare a domain name part of an email address in the first contact record with a domain name part of an email address in the second contact record.

Similarly, in at least some example embodiments, at 302, the contact manager 226 compares a last name 162a specified in a first contact record 300a (which may be contained in a last name field 122a) with a last name 162b specified in the second contact record 300b (which may be contained in a last name field 122b) to determine whether the contacts share the same last name.

The contact manager 226 may, in at least some example embodiments, compare data in other fields apart from those specifically described herein.

At 304, the contact manager 226 determines whether the contacts associated with the contact records which were compared at 302 are related. That is, based on the comparison which occurred at 302, the contact manager 226 determines whether the first contact (associated with the first contact record 300a which was used in the comparison at 302) and the second contact (associated with the second contact record 300b which was used in the comparison at 302) are related.

The determination regarding whether the first contact is related to the second contact may be made, for example, based on the similarities in the data identified at 302. That is, the results of the comparison may be used to determine whether the contacts are related. For example, in at least some example embodiments, any of the following results may suggest to the contact manager 226 that a relationship exists between the contacts: the contacts have the same last name, the contacts have a common domain name part of an email address and the email address is not associated with a public email service (which may be determined by the contact manager 226 by comparing the domain name portion to a list of domain name parts known to be associated with public email services, such as gmail.com, Hotmail.com, yahoo.com, etc.), the contacts have a common home phone number, the contacts have a common home address, the contacts have a common organization name, the contacts have a common work address, the contacts have a common web page address, the contacts have a common work phone number and/or the contacts have a common fax number.

In some example embodiments, the existence of any one of the results listed above will, taken alone, cause the contact manager 226 to conclude that the contacts are related. In other example embodiments, one or more of the results listed above will not, taken alone, cause the contact manager 226 to conclude that the contacts are related. That is, the existence of one of the results listed above may be considered indicia that the contacts may be related but such a result may not, itself, cause the contact manager 226 to conclude that the contacts are related. In at least some example embodiments, the contact manager 226 may not determine that the contacts are related unless enough indicia exist. For example, in at least some example embodiments, each condition which tends to suggest that the contacts are related is pre-assigned a given score. For example, each of the following conditions may be assigned a score: the contacts have the same last name, the contacts have a common domain name part of an email address and the email address is not associated with a public email service (which may be determined by the contact manager 226 by comparing the domain name portion to a list of domain name parts known to be associated public email services, such as gmail.com, Hotmail.com, yahoo.com, etc.), the contacts have a common home phone number, the contacts have a common home address, the contacts have a common organization name, the contacts have a common work address, the contacts have a common web page address, the contacts have a common work phone number and/or the contacts have a common fax number.

The contact manager 226 determines which of the conditions exist based on the result of the comparison at 302 and determines an overall confidence-of-relation score based on the scores for the conditions which were found to exist. If the overall confidence-of-relation score exceeds a predetermined threshold, then the contact manager 226 may determine that the contacts are related.

In at least some example embodiments, if the first contact and the second contact are not found to be related, then at 306, the contact manager 226 may not establish a relationship between the contact records.

However, if the first contact and the second contact (i.e. the contacts associated with the contact records compared at 302) are found to be related then, at 308, the contact manager 226 may establish a relationship, in memory, between the first contact record and the second contact record. That is, the contact manager 226 may store relationship information to memory of the electronic device 201 (or to memory of another system or device) to track the relationship between the contact records. That is, the relationship information specifies that the contact records which were compared at 302 are associated with contacts that are related.

In at least some example embodiments, at 308, the relationship information may be stored in the contact records 300a-300d themselves. For example, a first contact record 300a may store an identifier of another contact record which is related to the first contact record. In other example embodiments, the relationship information may be stored outside of the contact records; for example, in a separate relationship database.

In at least some example embodiments, the contact manager 226 may allow a user of the electronic device 201 to confirm, edit or delete the relationship information prior to or after storing such information. For example, in some example embodiments, before the contact manager 226 stores relationship information to specify that the first contact record 300a and the second contact record 300b are related, the contact manager 226 may prompt a user to confirm the relationship between the contact records.

In at least some example embodiments, relationship information which identifies relationships between contacts may be used to allow the electronic device 201 to generate a contact tree 400 (of FIG. 4). Accordingly, in at least some example embodiments, at 310, the contact manager 226 displays a contact tree 400. The contact tree is a graphical depiction of contacts and their relationships. More particularly, the contact tree is a display screen which visually depicts the relationships of contacts. For example, the contact tree may include a contact identifier for a contact (which may be a name associated with the contact) and a line may connect contact identifiers for related contacts. That is, a line may be used to visually depict a relationship.

### Contact Tree

Referring now to FIG. 4, an example contact tree 400 is illustrated for the example contact records 300a-300c of FIG. 2.

The example contact tree 400 includes a plurality of contact identifiers 402a, 402b, 402. Each of the contact identifiers 402a, 402b, 402c uniquely identifies one of the contact records 300a-300c. In the example illustrated, the contact identifier is a name extracted from the contact record. The name is the name of the contact associated with the contact record.

The contact tree 400 also includes one or more relationship identifiers 404a, 404b. The relationship identifiers identify a relationship between the contacts. That is, the relationship identifiers visually identify that contacts are known to one another. In the illustrated example, a first relationship identifier 404a illustrates a relationship between a first contact record 300a and a third contact record 300c. Similarly, a second relationship identifier 404b illustrates a relationship between the first contact record 300a and a second contact record 300b.

In the example illustrated, the relationship identifiers are illustrated as lines connecting contact identifiers for related contact records. However, in other example embodiments, the relationship identifiers may take other forms.

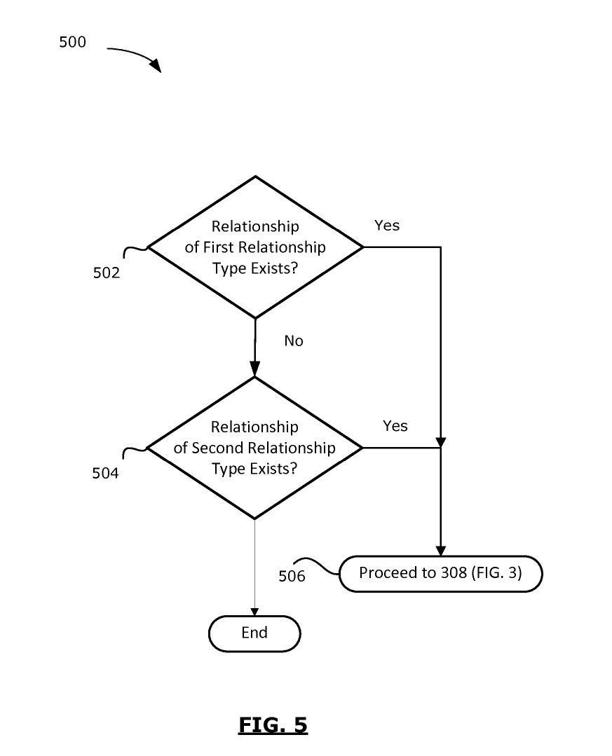

The contact tree 404 may, in at least some example embodiments, visually depict the type of the relationship between contacts. For example, as will be explained in greater detail below with reference to FIG. 5, in at least some example embodiments, the contact manager 226 may track whether contacts have a familial relationship and also whether contacts have a work relationship. In at least some example embodiments, the contact tree 404 may identify whether a pair of contacts has a familial relationship or whether the pair of contacts has a work relationship. In the example illustrated, the relationship identifier 404a, 404b is used to convey a relationship type. That is, a separate relationship identifier is used when contacts are family members than is used when the contacts are co-workers. In the illustrated example, a solid line is used to depict a familial relationship and a broken line is used to depict a working relationship. Other types of relationship identifiers could, however, be used in other example embodiments.

In some example embodiments, contact tree 404 may be included within a display of a contact record 300a-300c. In some example embodiments, contact tree 404 may be displayed in association with a display of one of the fields of contact record 300a-300c. For example, in an application where an email address of a contact record is displayed (such as in an email addressed to the email address), a display of a menu of functions and/or information associated with that email address may be invoked and contact tree 404 may be displayed within the displayed information.

### Identifying Relationship Type

As noted briefly above, in at least some example embodiments, the contact manager 226 may be configured to determine relationship type information by comparing the contents of two contact records. An example of a method 500 of identifying a relationship type is illustrated in FIG. 5. The method 500 may be performed, in at least some example embodiments, at 304 of FIG. 3.

The electronic device 201 (of FIG. 1) may be configured to perform the method 500 of FIG. 5. In at least some example embodiments, the processor 240 of the electronic device 201 is configured to perform the method 500 of FIG. 5. One or more applications 224 (of FIG. 1) or modules on the electronic device 201 (of FIG. 1) may contain computer readable instructions which cause the processor 240 (of FIG. 1) of the electronic device 201 to perform the method 500 of FIG. 5. In at least some example embodiments, the contact manager 226 (of FIG. 1) and/or the communication application 225 (of FIG. 1) stored in memory of the electronic device 201 is configured to perform the method 500 of FIG. 5. More particularly, the contact manager 226 and/or the communication application 225 may contain computer readable instructions which, when executed, cause the processor 240 to perform the method 500 of FIG. 5. It will be appreciated that the method 500 of FIG. 5 may, in at least some example embodiments, be provided by other software applications or modules apart from those specifically discussed above, such as the operating system 222. Accordingly, any features which are referred to as being performed by the electronic device 201 may be performed by any one or more of the software applications or modules referred to above or other software modules. Accordingly, references to the “contact manager” below could be replaced with the names of other applications or modules in other example embodiments.

In at least some example embodiments, at least some of the method 500 of FIG. 5 may be performed by or may rely on other applications 224 or modules which interface with the contact manager 226. For example, the contact manager 226 may be equipped with an application programming interface (API) which allows other software applications 224 or modules (such as the communication application 225) to access features of the contact manager 226.

The method 500 may, in at least some example embodiments, be performed following 302 of FIG. 3. That is, the method 500 may, in at least some example embodiments, be performed based on the results from the comparison at 302.

At 502, the electronic device determines whether a relationship of a first relationship type exists between the first contact and the second contact. This determination may be performed based on the result of the comparison (at 302) of the data in the contact records 300a, 300b. For example, in some example embodiments, the first relationship type is a familial relationship. In at least some example embodiments, the contact manager 226 may determine, at 502, whether a familial relationship exists based on one or more of: a comparison between a home address in the first contact record and a home address in the second contact record; a comparison of a home phone number in the first contact record and a home phone number in the second contact record; or a comparison of a last name in the first contact record and a last name in the second contact record. That is, the fact that the contact records contain a common home address, home phone number and/or last name may be interpreted by the contact manager 226 as indicia that a familial relationship exists. If sufficient indicia suggest that a familial relationship exists, then the contact manager 226 may determine that a familial relationship exists.

In at least some example embodiments, if the contact manager 226 determines that a relationship of the first relationship type exists (e.g. if it determines that the contacts are family members) then, at 506, the method 500 may proceed to 308 of FIG. 3. That is, the 308 of FIG. 3 may then be performed. More particularly, the contact manager 226 may store relationship information to track the existence of the relationship. The relationship information may include relationship type information to specify that a familial relationship exists.

If, however, the contact manager 226 does not identify a relationship of the first relationship type (e.g. a familial relationship), then at 504, the contact manager 226 determines whether a relationship of a second relationship type exists between the first contact and the second contact. This determination may be performed based on the result of the comparison (at 302) of the data in the contact records. For example, in some example embodiments, the second relationship type is a work relationship. In at least some example embodiments, the contact manager 226 may determine whether a work relationship exists based on one or more of: a comparison between a web page address in the first contact record and a web page address in the second contact record; a comparison of a work address in the first contact record with a work address in the second contact record; a comparison of a work phone number in the first contact record and a work phone number in the second contact record; a comparison of a fax number in the first contact record and a fax number in the second contact record; a comparison of a domain name part of an email address in the first contact record and a domain name part of an email address in the second contact record; or a comparison of organization name in the first contact record with a organization name in the second contact record. That is, the fact that the contact records contain a common web page address, work address, work phone number, fax number, domain name part of an email address, and/or organization name may be interpreted by the contact manager 226 as indicia that a work relationship exists. If sufficient indicia suggest that a work relationship exists, then the contact manager 226 may determine that a work relationship exists.

In at least some example embodiments, if the contact manager 226 determines that a relationship of the second relationship type exists (e.g. the contacts are co-workers) then, at 506, the method 500 may proceed to 308 of FIG. 3. That is, the 308 of FIG. 3 may then be performed. More particularly, the contact manager 226 may store relationship information to track the existence of the relationship. The relationship information may include relationship type information to specify that a work relationship exists.

### Populating a Related Contact Record

In at least some example embodiments, if a first contact and a second contact are determined to be related, then a portion of a contact record 300a, 300b for one of the first contact or the second contact may be populated based on data from the other of the contact records for the first contact or the second contact. For example, if the first contact and the second contact are determined to be related, then the contact manager 226 may populate a portion of the first contact record 300a based on data from the second contact record 300b.

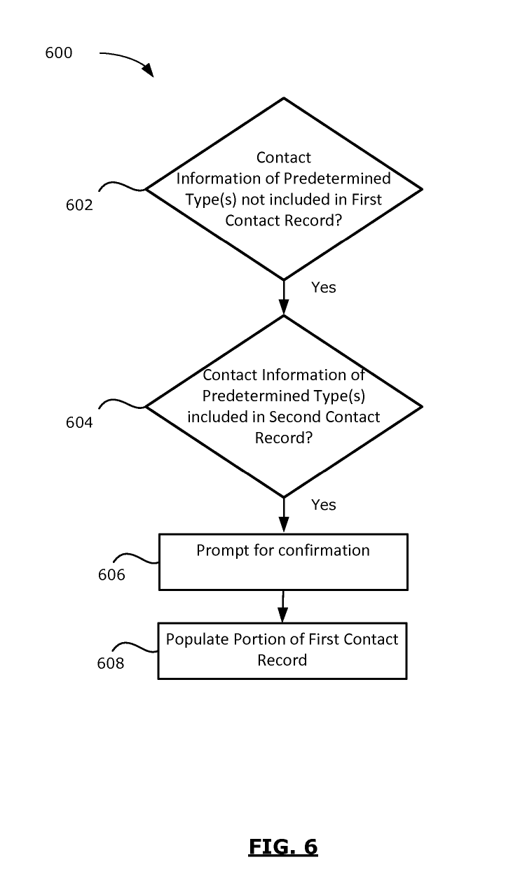

Referring now to FIG. 6, an example method 600 of populating a contact record based on information for a related contact record is illustrated. The method 600 may, in some example embodiments, be performed in conjunction with the method 301 of FIG. 3. For example, in at least some example embodiments, the method 600 of FIG. 6 may be performed after 304 of FIG. 3.

The electronic device 201 (of FIG. 1) may be configured to perform the method 600 of FIG. 6. In at least some example embodiments, the processor 240 of the electronic device 201 is configured to perform the method 600 of FIG. 6. One or more applications 224 (of FIG. 1) or modules on the electronic device 201 (of FIG. 1) may contain computer readable instructions which cause the processor 240 (of FIG. 1) of the electronic device 201 to perform the method 600 of FIG. 6. In at least some example embodiments, the contact manager 226 (of FIG. 1) and/or the communication application 225 (of FIG. 1) stored in memory of the electronic device 201 is configured to perform the method 600 of FIG. 6. More particularly, the contact manager 226 and/or the communication application 225 may contain computer readable instructions which, when executed, cause the processor 240 to perform the method 600 of FIG. 6. It will be appreciated that the method 600 of FIG. 6 may, in at least some example embodiments, be provided by other software applications or modules apart from those specifically discussed above, such as the operating system 222. Accordingly, any features which are referred to as being performed by the electronic device 201 may be performed by any one or more of the software applications or modules referred to above or other software modules. Accordingly, references to the “contact manager” below could be replaced with the names of other applications or modules in other example embodiments.

In at least some example embodiments, at least some of the method 600 of FIG. 6 may be performed by or may rely on other applications 224 or modules which interface with the contact manager 226. For example, the contact manager 226 may be equipped with an application programming interface (API) which allows other software applications 224 or modules (such as the communication application 225) to access features of the contact manager 226.

At 602, the contact manager 226 determines whether contact information of one or more predetermined types are not included in the first contact record 300a. That is, the contact manager 226 determines whether a certain type of contact information is not included in the first contact record 300a.

The predetermined types may, in at least some example embodiments, depend on the relationship type of the relationship between the first contact record and the second contact record. That is, the contact manager 226 may use the relationship type in order to determine which fields of a contact record will be populated based on information from a related contact record. If the relationship between the contacts is a familial relationship then a different field or set of fields may be populated than if the relationship between the contacts is a work relationship.

Accordingly, in at least some example embodiments, if the relationship between the contacts is a work relationship, then the predetermined types are selected from a group which includes: a organization name, a fax number, a work phone number, a work address, or a web page address. That is, if the relationship between the contacts is a work relationship, then at 602, the contact manager 226 may determine whether the first contact record 300a is missing a organization name, fax number, work phone number, work address, and/or a web page address.

If, however, the relationship between the contact is a familial relationship, then the predetermined types may be selected from a different group which may include: a home address, a home phone number, or a last name.

If, at 602, the contact manager 226 determines that contact information of the predetermined types are missing from the first contact record 300a, then at 604, the contact manager 226 may determine whether contact information of those same types are included in a second contact record 300b which is related to the first contact record 300a. That is, the contact manager 226 may determine whether the second contact record 300b includes the information missing from the first contact record 300a.

In some example embodiments, if the second contact record 300b includes the information which was missing from the first contact record 300a (i.e. if contact information of the predetermined type is not included in the first contact record and contact information of the predetermined type is included in the second contact record), then the contact manager 226 may display a prompt, at 606, on a display 204 of the electronic device requesting a user to confirm the populating of a portion of the first contact record based on information from the second contact record. That is, the electronic device 201 may ask the user whether they would like to populate a portion of the first contact record with data from the second contact record.

If confirmation is received, then at 608, the contact manager 226 may populate a portion of the first contact record with contact information of the predetermined type from the second contact record. That is, the contact manager 226 may obtain the information which is missing from the first contact record 300a from a corresponding portion of the second contact record 300b and may add that information to the first contact record 300a to render the first contact record 300a more complete. The modified first contact record may be stored in memory of the electronic device 201.

While FIG. 6 illustrates an example embodiment in which a contact record is modified based on data from a related contact record, in other example embodiments, information from a related contact record may be displayed when a contact record is displayed. For example, the contact manager 226 may display data from a first contact record and, if the first contact record and the second contact record are determined to be related, may display data from the second contact record with the data from the first contact record to complement incomplete portions of the first contact record. That is, in at least some example embodiments, when data from a first contact record is displayed, data from a second related contact record may be displayed concurrently with the data from the first contact record.

Furthermore, in at least some example embodiments, relationships between two contact records may be established based on user input. That is, a user may be permitted to manually define a relationship (i.e. operation 308 of the method 300 of FIG. 3). In at least some such example embodiments, features of the methods described herein may be provided based on the user-defined relationships. For example, operation 310 of the method 300 of FIG. 3 may be performed to display a contact tree based on the user-defined relationships. Similarly, the method 600 of FIG. 6 may be performed based on the user-defined relationships to populate a contact record based on a related contact record. Similarly, in the manner described in the paragraph immediately above, when data from a first contact record is displayed, data from another contact record, which a user has defined as related to the first contact record, may also be displayed.

While the present application is primarily described in terms of methods, a person of ordinary skill in the art will understand that the present application is also directed to various apparatus such as an electronic device 201 including a mobile communications device. The electronic device 201 includes components for performing at least some of the aspects and features of the described methods, which may be by way of hardware components (such as the memory 244 and/or the processor 240), software or any combination of the two, or in any other manner. Moreover, an article of manufacture for use with the apparatus, such as a pre-recorded storage device or other similar computer readable medium including program instructions recorded thereon, or a computer data signal carrying computer readable program instructions may direct an apparatus to facilitate the practice of the described methods. It is understood that such apparatus, articles of manufacture, and computer data signals also come within the scope of the present application.

The term “computer readable medium” as used herein means any medium which can store instructions for use by or execution by a computer or other computing device including but not limited to, a portable computer diskette, a hard disk drive (HDD), a random access memory (RAM), a read-only memory (ROM), an erasable programmable-read-only memory (EPROM) or flash memory, an optical disc such as a Compact Disc (CD), Digital Versatile Disc (DVD) or Blu-ray™ Disc, and a solid state storage device (e.g., NAND flash or synchronous dynamic RAM (SDRAM)).

Example embodiments of the present application are not limited to any particular operating system, system architecture, mobile device architecture, server architecture, or computer programming language.

The various example embodiments presented above are merely examples and are in no way meant to limit the scope of this application. Variations of the innovations described herein will be apparent to persons of ordinary skill in the art, such variations being within the intended scope of the present application. In particular, features from one or more of the above-described example embodiments may be selected to create alternative example embodiments including a sub-combination of features which may not be explicitly described above. In addition, features from one or more of the above-described example embodiments may be selected and combined to create alternative example embodiments including a combination of features which may not be explicitly described above. Features suitable for such combinations and sub-combinations would be readily apparent to persons skilled in the art upon review of the present application as a whole. The subject matter described herein and in the recited claims intends to cover and embrace all suitable changes in technology.

1. A method performed by a processor, the method comprising:
comparing data from a first contact record associated with a first contact to data from a second contact record associated with a second contact;
determining, based on the comparison, whether the first contact is related to the second contact and if so, establishing a relationship, in memory, between the first contact record and the second contact record.

2. The method of claim 1, wherein comparing data from a first contact record associated with a first contact to data from a second contact record associated with a second contact comprises:
comparing a home address from the first contact record with a home address from the second contact record.

3. The method of claim 1, wherein comparing data from a first contact record associated with a first contact to data from a second contact record associated with a second contact comprises:
comparing a work address from the first contact record with a work address from the second contact record.

4. The method of claim 1, wherein comparing data from a first contact record associated with a first contact to data from a second contact record associated with a second contact comprises:
comparing a web page address contained in the first contact record with a web page address contained in the second contact record.

5. The method of claim 1, wherein comparing data from a first contact record associated with a first contact to data from a second contact record associated with a second contact comprises:
comparing a phone number contained in the first contact record with a phone number contained in the second contact record.

6. The method of claim 1, wherein comparing data from a first contact record associated with a first contact to data from a second contact record associated with a second contact comprises:
comparing a last name specified in the first contact record with a last name specified in the second contact record.

7. The method of claim 1, wherein determining whether the first contact is related to the second contact comprises:
determining whether a relationship of a first relationship type exists between the first contact and the second contact; and
determining whether a relationship of a second relationship type exists between the first contact and the second contact.

8. The method of claim 7, wherein the first relationship type is a familial relationship and wherein the second relationship type is a work relationship.

9. The method of claim 7, wherein the determination of whether a relationship of the first relationship type exists is performed based on one or more of:
a comparison between a home address in the first contact record and a home address in the second contact record;
a comparison of a home phone number in the first contact record and a home phone number in the second contact record; or
a comparison of a last name in the first contact record and a last name in the second contact record.

10. The method of claim 7, wherein the determination of whether a relationship of the second relationship type exists is performed based on one or more of:
a comparison between a web page address in the first contact record and a web page address in the second contact record;
a comparison of a work address in the first contact record with a work address in the second contact record;
a comparison of a work phone number in the first contact record and a work phone number in the second contact record;
a comparison of a fax number in the first contact record and a fax number in the second contact record;
a comparison of a domain name part of an email address in the first contact record and a domain name part of an email address in the second contact record; or
a comparison of an organization name in the first contact record with an organization name in the second contact record.

11. The method of claim 1, further comprising:
if the first contact and the second contact are determined to be related, populating a portion of the first contact record based on data from the second contact record.

12. The method of any claim 11, further comprising, prior to populating a portion of the first contact record based on data from the second contact record:
displaying a prompt to confirm the populating of the portion of the first contact record.

13. The method of claim 1, further comprising:
determining if contact information of a predetermined type is not included in the first contact record;
determining if contact information of the predetermined type is included in the second contact record; and
if contact information of the predetermined type is not included in the first contact record and contact information of the predetermined type is included in the second contact record, then:
populating a portion of the first contact record with the contact information of the predetermined type from the second contact record.

14. The method of claim 13, wherein the predetermined type depends on a relationship type of the relationship between the first contact and the second contact.

15. The method of claim 14, wherein, if the relationship of the first contact and the second contact is a work relationship, then the predetermined type is selected from the group comprising: an organization name, a fax number, a work phone number, a work address, or a web page address.

16. The method of claim 14, wherein, if the relationship of the first contact and the second contact is a familial relationship, then the predetermined type is selected from the group comprising: a home address, a home phone number, or a last name.

17. The method of claim 16, further comprising:
displaying data from the first contact record; and
if the first contact and the second contact are determined to be related, displaying data from the second contact record with the data from the first contact record to complement incomplete portions of the first contact record.

18. The method of claim 17, further comprising:
displaying a contact tree, the contact tree identifying a plurality of contacts and visually representing relationships between the contacts.

19. An electronic device comprising:
a memory storing a first contact record and a second contact record; and
a processor coupled to the memory, the processor being configured to perform the method of claim 1.

20. A method performed by a processor, the method comprising:
determining if contact information of a predetermined type is not included in a first contact record;
determining if contact information of the predetermined type is included in a second contact record, the second contact record and the first contact record being associated with related contacts; and
if contact information of the predetermined type is not included in the first contact record and contact information of the predetermined type is included in the second contact record, then:
populating a portion of the first contact record with the contact information of the predetermined type from the second contact record.
